(19) United States
(12) Patent Application Publication
(10) Pub. No.: US 2022/0343259 A1
(43) Pub. Date: Oct. 27, 2022

(54) METHOD AND SYSTEM OF VIDEO-BASED REMOTE WORK PLATFORM AND APPLICATIONS

(71) Applicant: DANIELLE ERICA CENTER, SANTA CLARA, CA (US)

(72) Inventor: DANIELLE ERICA CENTER, SANTA CLARA, CA (US)

(21) Appl. No.: 17/727,740

(22) Filed: Apr. 23, 2022

Related U.S. Application Data
(60) Provisional application No. 63/179,133, filed on Apr. 23, 2021.

(51) Int. Cl. G06Q 10/06; G06Q 10/10

(52) U.S. Cl. CPC G06Q 10/063114; G06Q 10/063112; G06Q 10/1093

(57) ABSTRACT

A computerized system comprising: a video-based remote work platform of an enterprise, wherein the video-based remote work platform manages and provides a remote work dashboard, the video-based remote work platform comprising: a contact management system that manages a set of employee information and a set of employee interactions, wherein the contact management system is integrated with the desktop application of the video-based remote work platform, and wherein the contact management system manages a display of a set of contacts of an employee, and wherein the contact management system comprises: contact-status display module that manages a content of the employee's contact avatars in the remote work dashboard, is used to update a employees's current status in the remote work dashboard, a future status of the employee in the remote work dashboard, a current project of employee in the remote work dashboard; contact-calendar access module that manages a calendaring system of the employee, enables other contact to access the user's calendar system; and contact video management module that enables the employee to create and send a video message to set of contacts, enables the employee to generate a template contact message and enables the employee to generate and send a pre-generated video message.

### CLAIM OF PRIORITY

This application claims priority to U.S. Provisional Patent Application No. 63/179,133, filed on 23 Apr. 2021, and titled METHOD AND SYSTEM OF VIDEO-BASED REMOTE WORK PLATFORM AND APPLICATIONS. This provisional application is hereby incorporated by reference in its entirety.

### SUMMARY OF THE INVENTION

A computerized system comprising: a video-based remote work platform of an enterprise, wherein the video-based remote work platform manages and provides a remote work dashboard, the video-based remote work platform comprising: a contact management system that manages a set of employee information and a set of employee interactions, wherein the contact management system is integrated with the desktop application of the video-based remote work platform, and wherein the contact management system manages a display of a set of contacts of an employee, and wherein the contact management system comprises: contact-status display module that manages a content of the employee's contact avatars in the remote work dashboard, is used to update a employees's current status in the remote work dashboard, a future status of the employee in the remote work dashboard, a current project of employee in the remote work dashboard; contact-calendar access module that manages a calendaring system of the employee, enables other contact to access the user's calendar system; and contact video management module that enables the employee to create and send a video message to set of contacts, enables the employee to generate a template contact message and enables the employee to generate and send a pre-generated video message.

### BRIEF DESCRIPTION OF THE DRAWINGS

The present application can be best understood by reference to the following description taken in conjunction with the accompanying figures, in which like parts may be referred to by like numerals.

FIGS. 1-22 illustrates a set of example screenshots of a video-based remote work platform, according to some embodiments.

FIG. 1 shows the home screen dashboard or main interface of the video-based remote work platform.

FIG. 2A shows the home screen dashboard or main interface of the video-based remote work platform, with the screen that highlight the work status of a team member.

FIG. 2B show the team member profile page.

FIG. 3 shows the home screen dashboard show the team member's login time.

FIG. 4 shows the video creation module where a team member can send a video message right through the platform.

FIG. 5 shows the screen with a completed video message is shown and he can select a colleague on the platform or by email to send the video message to.

FIG. 6 shows how team members can record video status updates.

FIG. 7 shows the audio and/or video message is transcribed and then both are sent through the platform to another team member.

FIG. 8 shows the artificial intelligence transcribes the audio or video message and creates a report that is archived on the cloud platform.

FIG. 9 shows the audio and/or video message is transcribed and then both audio and video and text versions are sent through the platform to another team member.

FIG. 10 shows the platform has a one-click integration with other major software such as Google Drive, Google Calendar, Microsoft Teams, Zoom and Asana.

FIG. 11 shows the platform has a “Progress” module where it takes information inputted by the team and from the audio and video messages and create reports.

FIG. 12 shows the Motivational Feature module.

FIG. 13 shows the “Inspirational Image and Quote” module.

FIG. 14 shows the “team member points game”.

FIG. 15 shows the “Redeem Your Points” section of the motivational module.

FIG. 16 shows the platform has a “Progress” module and this is the “Projects” section.

FIG. 17 shows redeeming points.

FIG. 18 shows the “Team Recognition Module” where team members can announce to the rest of the team the points and positive statements about their colleagues.

FIG. 19 shows the “Virtual Hangout Room” and this is a space where team members can drop in for a virtual chat.

FIG. 20 shows the platform has a “Progress” module and this is the “Tasks” section.

FIG. 21 shows the platform has a “Progress” module and this is the “Departments” section.

FIG. 22 shows a summary of the benefits.

FIG. 23 illustrates an example system for implementing a video-based remote work platform, according to some embodiments.

FIG. 24 depicts an exemplary computing system that can be configured to perform any one of the processes provided herein.

FIGS. 25-28 illustrate example screen shots of dashboard view of a contact management system, according to some embodiments.

FIG. 29 illustrates an example contact management system, according to some embodiments.

The Figures described above are a representative set, and are not an exhaustive with respect to embodying the invention.

### DESCRIPTION

Disclosed are a system, method, and article of manufacture for a video-based remote work platform and application(s). The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, relationship structures, logic-based algorithms, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Key performance indicator (KPI) is a type of performance measurement. KPIs can be used to evaluate/quantify the success of an enterprise and/or of a particular activity (e.g. projects, programs, products, other initiatives, etc.) of the enterprise.

Machine learning can include the construction and study of systems that can learn from data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Telepresence includes the cluster of technologies which enable a user to feel as if they were present at a place other than their true location.

TensorFlow is a free and open-source software library for machine learning. TensorFlow can be used across a range of tasks but has a particular focus on training and inference of deep neural networks. TensorFlow includes a symbolic math library based on dataflow and differentiable programming.

Exemplary Video-Based Remote Work Platform Methods and Interfaces

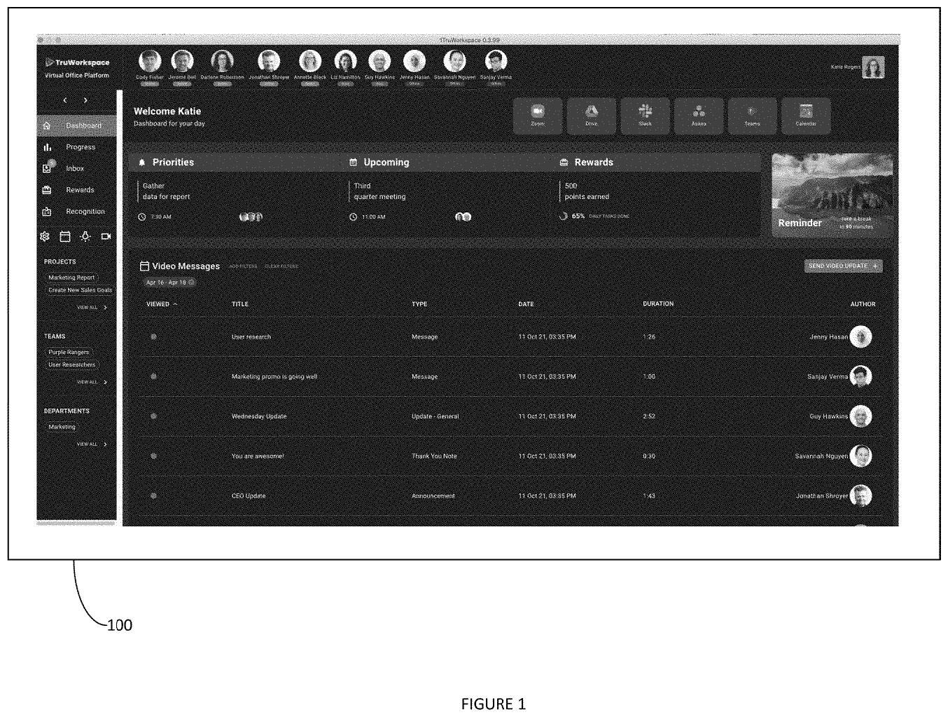

FIGS. 1-22 illustrates a set of example screenshots 100-2200 of a video-based remote work platform, according to some embodiments. As shown in screenshots 100-2200, video-based remote work platform can enable an enterprise to provide a remote-work environment. As shown, video-based remote work platform can provide various functionalities and features to enhance various aspects of the remote work experience. Video-based remote work platform can enhance a sense of community within the employees of the enterprise and thus enrich company culture. Video-based remote work platform can enhance team attitudes of connectedness, productivity and being valued, etc.

Example functionalities/applications provided by video-based remote work platform can include, inter alia: daily status video(s), updates, virtual hangout spaces, team member mood tracking, description board(s), motivation and goal development and tracking applications, gamification (e.g. KPI's into games, etc.), etc.

Video-based remote work platform can include various chat application, instant messaging (IM), videotelephony and/or other videoconferencing applications. Employee chat, messaging, videotelephony data can be converted to text and/or other metrics for later analysis. These chat, messaging, videotelephony applications can be used for collaborative video meetings, daily status updates, and managing detailed progress charts.

Video-based remote work platform can be integrated into third-party electronic communication platforms. For example, Video-based remote work platform can be integrated into a third-party videotelephony platform (e.g. Zoom®, etc.).

Employee/user data can be obtained and stored in a database. For example, employee metrics can be quantified. Employee status/update video can be analyzed (e.g. using text to speech functionalities). This data can be utilized for machine-learning (ML) processes. For example, this data can be used as a set of training and/or verification data sets to generate and train a ML model. Later data can be used by the model to output various employee scores and forecasts (e.g. sentiment scores, productivity scores, etc.). Additional ML processes are discussed infra.

For example, employees can provide a daily five-minute updated video recorded with a video-recording application of the Video-based remote work platform. This can be done for status high-level reporting. A voice/video to text application can transcribe and archive the videos. Artificial Intelligence applications transcribe videos into text, then archive and email (and/or otherwise digitally communicate) them to a manager and/or analyst. This data can be used to summarize employee/team motivation/morale states. Video-based remote work platform can provide various gamification & motivation methods to then incentivize employees when such actions are deemed useful. Video-based remote work platform can enable a manager to cluster various employees/teams for analysis in this manner.

Video-based remote work platform can enable team members to rate moods with emojis and notes such as “feeling motivated” or “feeling overwhelmed.” These ratings can also be used by AI/ML functionalities to obtain insight into the enterprise. For example, AI/ML functionalities can use this input to generate reports to managers about employee/team needs. In this way, the enterprise can acknowledge and understand their employees' needs. Video-based remote work platform can enable the management to then provide team feedback (e.g. given with stars and points to increase collaboration). This feedback can be used to create a positive and unifying environment for teams. Video-based remote work platform can enable the use daily motivational quotes and inspiration images to uplift employees.

Video-based remote work platform can enable the delivery of various credits. Enterprises can allocate a certain amount of coupons/credits (e.g. UberEats®, Postmates®, DoorDash® credits, etc.) to their employee on a recognition board. Management can reward employees when they complete a project or meet company goals. Video-based remote work platform can enable also select and display relaxing and motivational images and videos to employees based on their sentiment. In this way, management can maintain employee motivation high with both monetary and non-monetary rewards.

It is noted that various other types of institutions can utilize Video-based remote work platform other than for-profit enterprises. These can include, inter alia: churches, non-profit organizations, educational institutions, charities, sports teams, etc. It is noted that video-based remote work platform can provide a web-page interface and/or a mobile-device application interface.

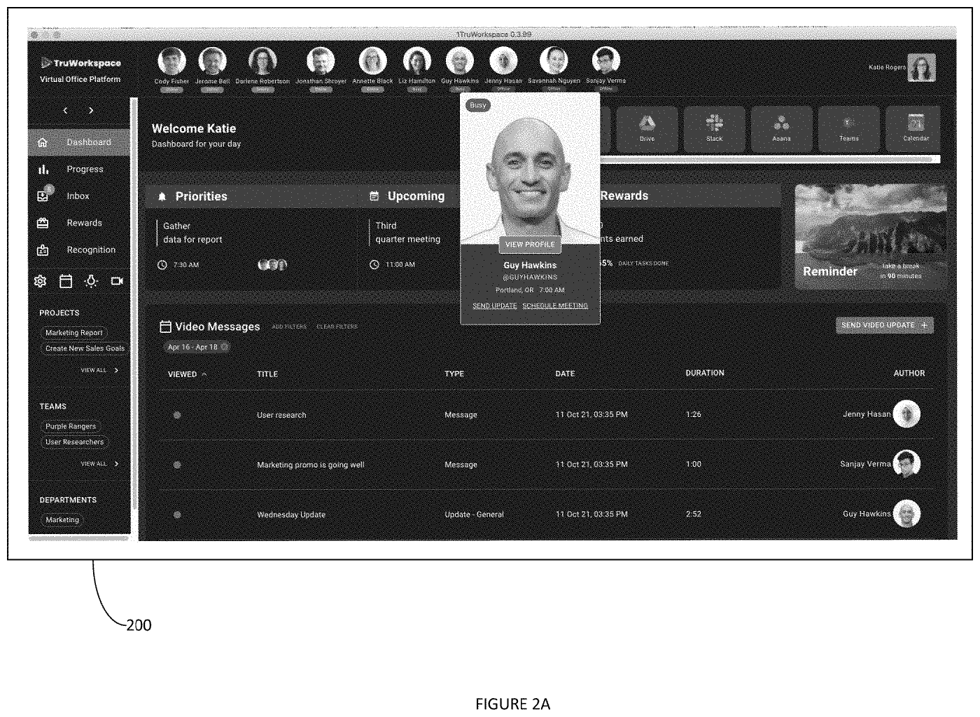

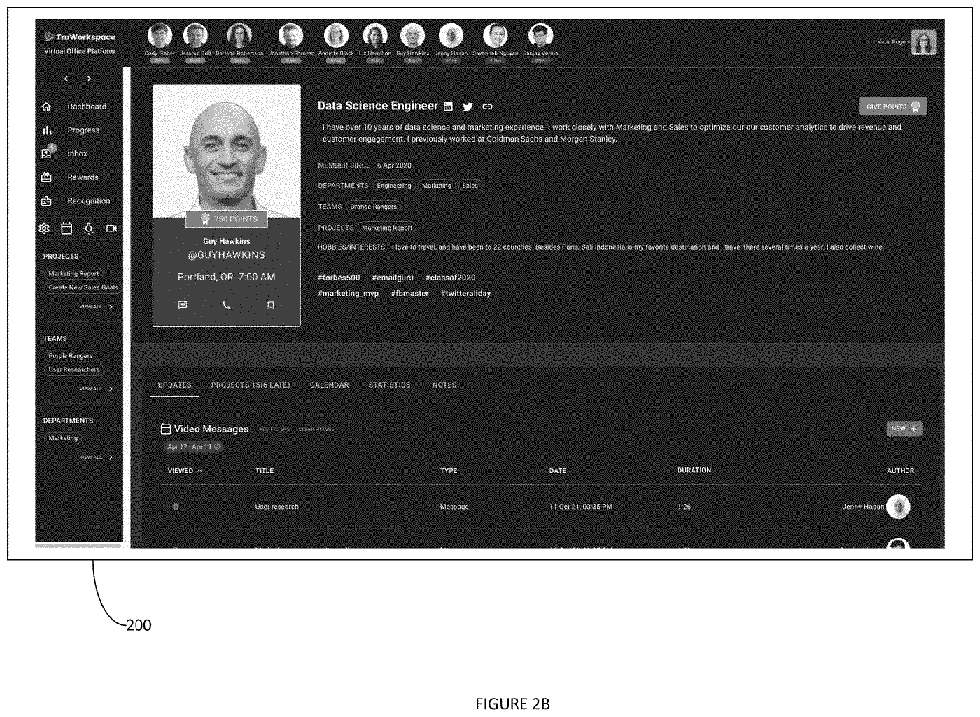

FIG. 1 shows the home screen dashboard or main interface of the video-based remote work platform. FIG. 2A shows the home screen dashboard or main interface of the video-based remote work platform, with the screen that highlight the work status of a team member. The team member profile status lists his name, location, time zone, username and the team member can put the status of what they are working on. FIG. 2B show the team member profile page. It details information about the individual team member such as name, title, department, date they joined the company, projects they are working on, their hash tags, phone number, email address, as well as, all the video message updates they have sent you in the past archived on the cloud based platform. It also has an area for their career bio and their personal interests and hobbies.

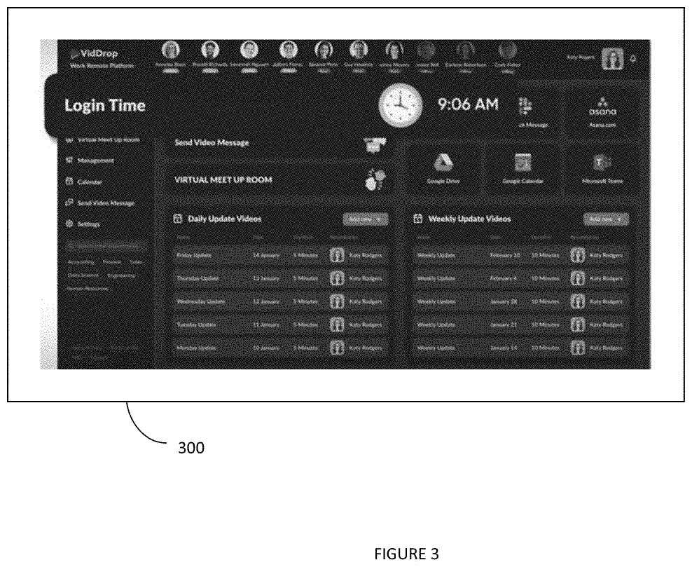

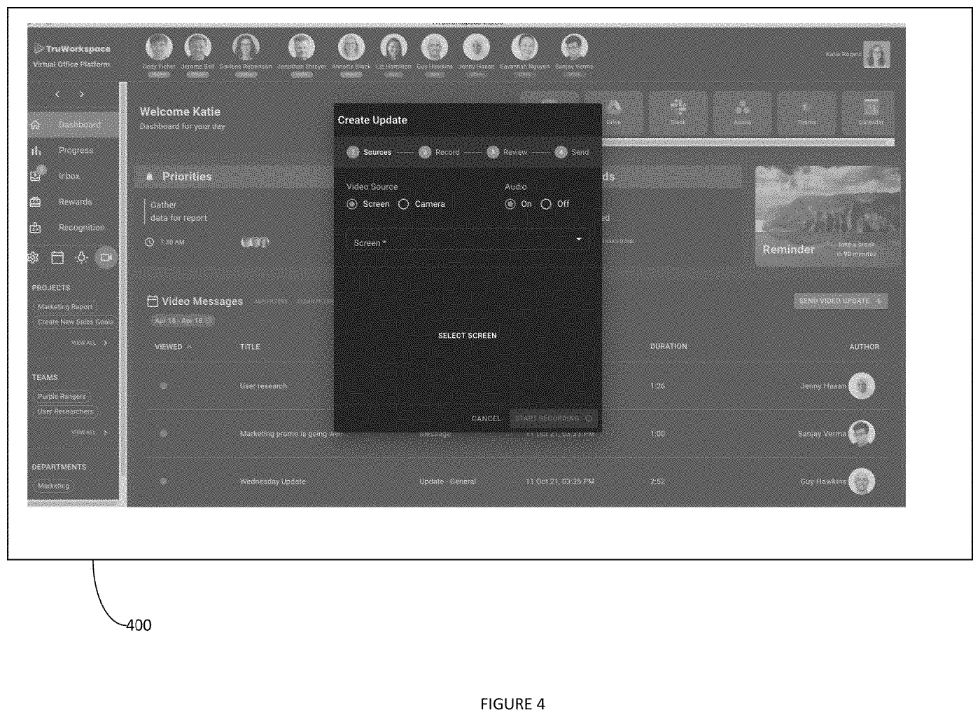

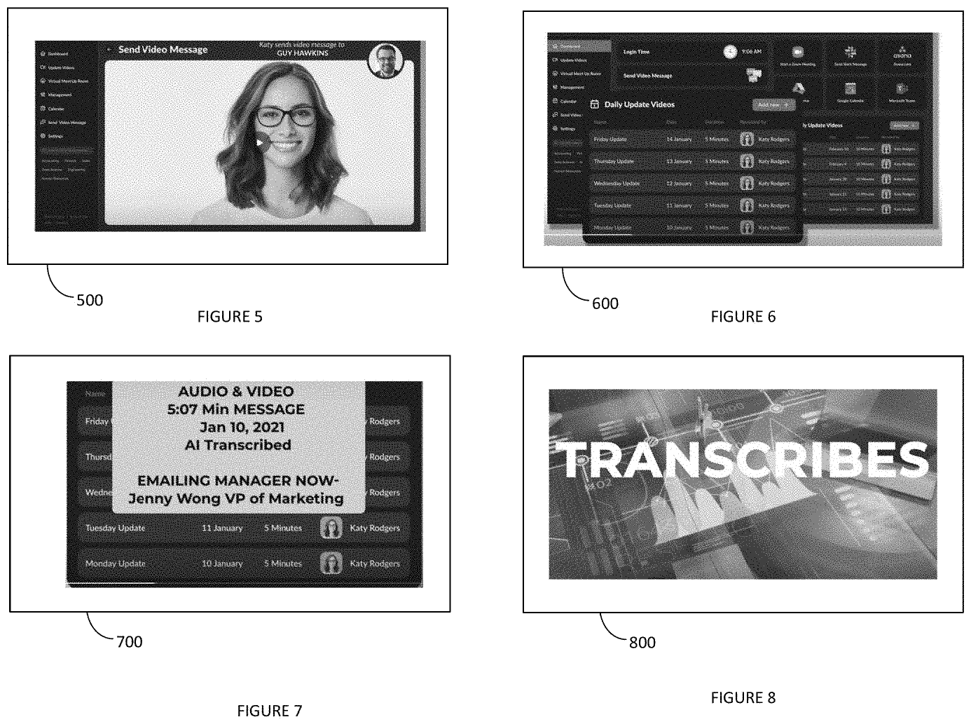

FIG. 3 shows the home screen dashboard show the team member's login time. This login module can synchronize with payroll companies like ADP or other employee clock software. FIG. 4 shows the video creation module where a team member can send a video message right through the platform. He can record just a video, a video and a screen recording or just an audio recording. All video and audio messages created are archived on the cloud platform. FIG. 5 shows the screen with a completed video message is shown and he can select a colleague on the platform or by email to send the video message to. FIG. 6 shows how team members can record video status updates. These videos are usually 2-30 minutes and then the artificial intelligence transcribes the audio into text and archives a text version on the cloud along with the audio or video message.

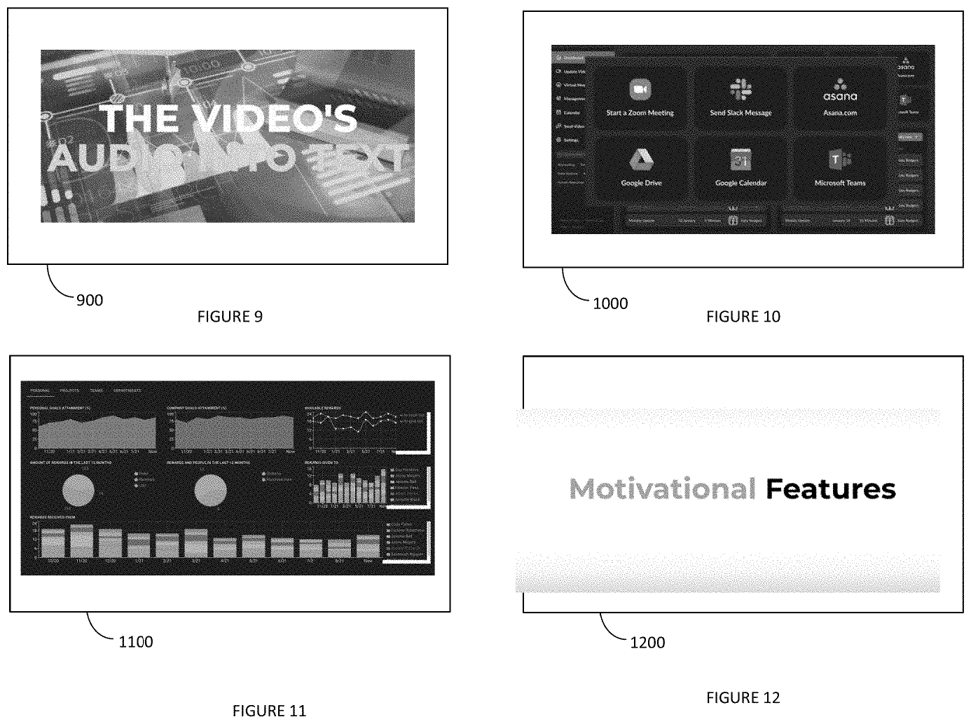

FIG. 7 shows the audio and/or video message is transcribed and then both are sent through the platform to another team member. FIG. 8 shows the artificial intelligence transcribes the audio or video message and creates a report that is archived on the cloud platform. FIG. 9 shows the audio and/or video message is transcribed and then both audio and video and text versions are sent through the platform to another team member.

FIG. 10 shows the platform has a one-click integration with other major software such as Google Drive, Google Calendar, Microsoft Teams, Zoom and Asana. The ease of our platform is that it is a dashboard where all your software can reside with one click. The integrations a more complex than a short cut, depending on the software, it can show alerts and real time updates. FIG. 11 shows the platform has a “Progress” module where it takes information inputted by the team and from the audio and video messages and create reports. There are reports like “personal goals”, “project level goals”, “team level goals” and “department level goals.” These report allow the company to stay on the same page while each team member is working remotely. The AI can also send reports based on triggers set by managers.

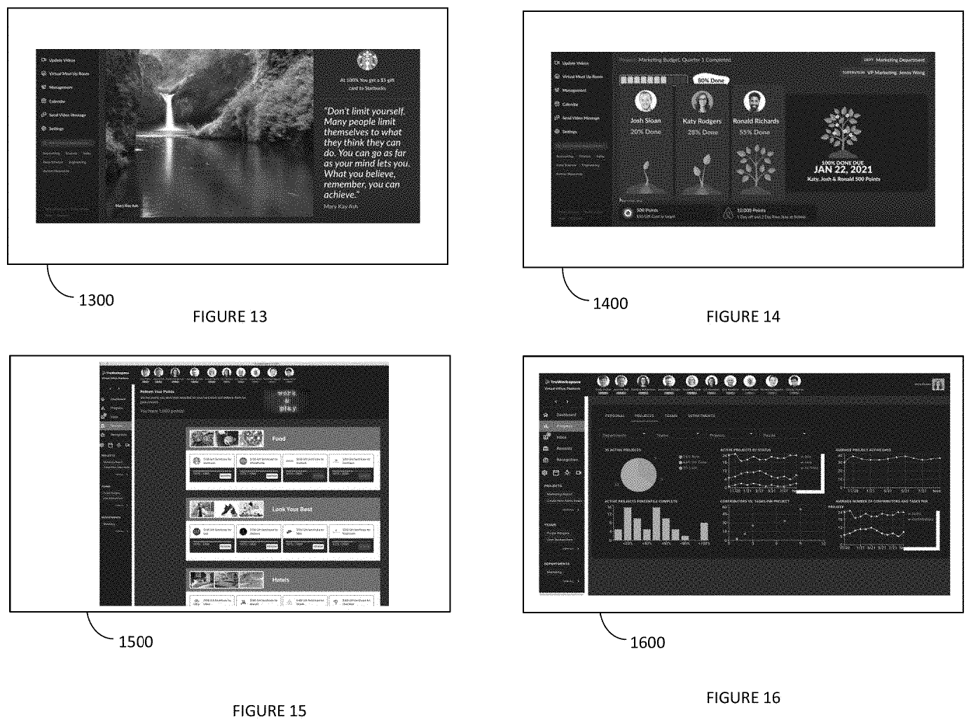

FIG. 12 shows the Motivational Feature module. FIG. 13 shows the “Inspirational Image and Quote” module. The platform has an auto reminder every 90 minutes to take a 10 to 15 minute break and the inspirational image and quote takes over the users platform screen. The individual team member can set the timer for when the inspirational image and quote appears throughout their day. FIG. 14 shows the “team member points game” The amount of points that each team member has is turned into a visual game. The interface looks like a video game. In this figure it is a tree that is growing as the project is completed.

FIG. 15 shows the “Redeem Your Points” section of the motivational module. The team member can give and receive points right on the platform. They can also redeem their points for gift cards for item categories like “Food”, “Look Your Best”, “Hotels”, “Shopping”, and “Pets.” They can also order physical products to be mailed to them through our e-commerce partners. FIG. 16 shows the platform has a “Progress” module and this is the “Projects” section.

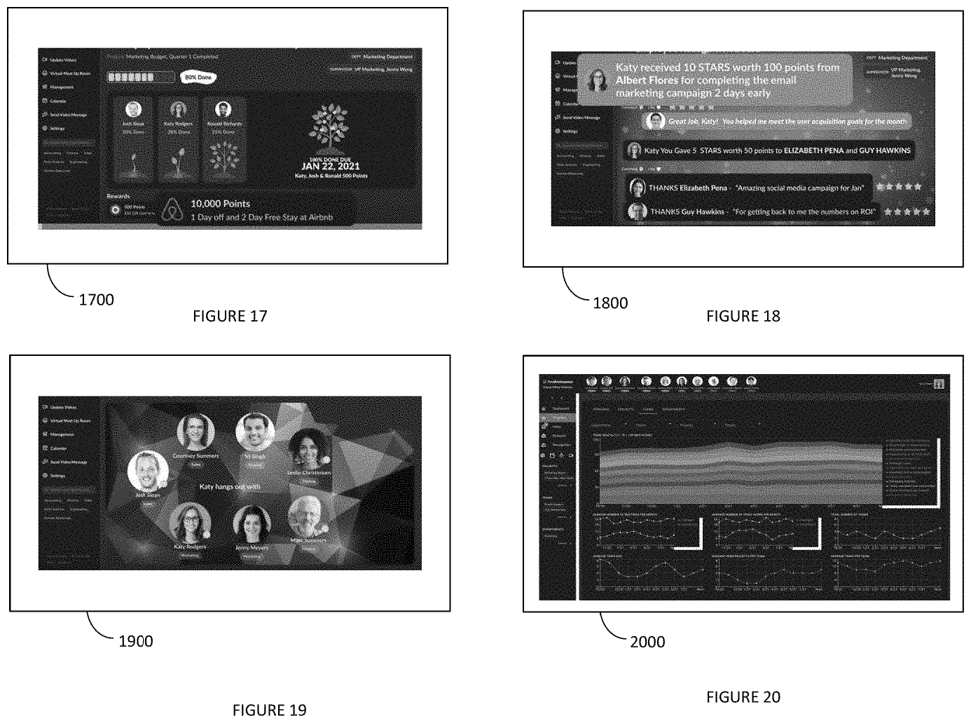

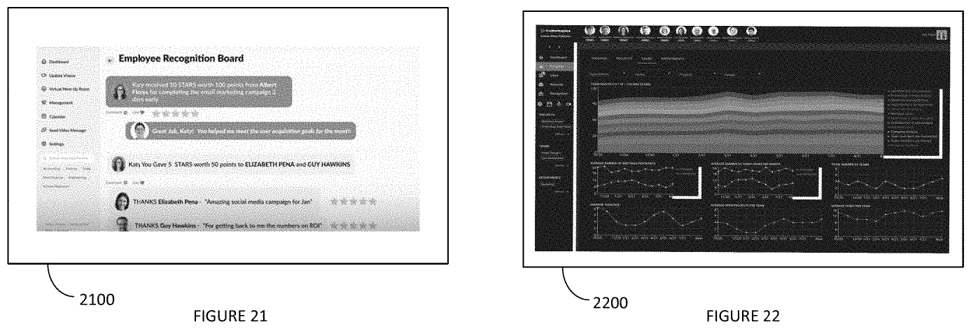

FIG. 17 shows redeeming points. FIG. 18 shows the “Team Recognition Module” where team members can announce to the rest of the team the points and positive statements about their colleagues. FIG. 19 shows the “Virtual Hangout Room” and this is a space where team members can drop in for a virtual chat. These are usually unscheduled drop ins between tasks to say hello to team members that are on a break. FIG. 20 shows the platform has a “Progress” module and this is the “Tasks” section. FIG. 21 shows the platform has a “Progress” module and this is the “Departments” section. FIG. 22 shows a summary of the benefits.

Example Systems

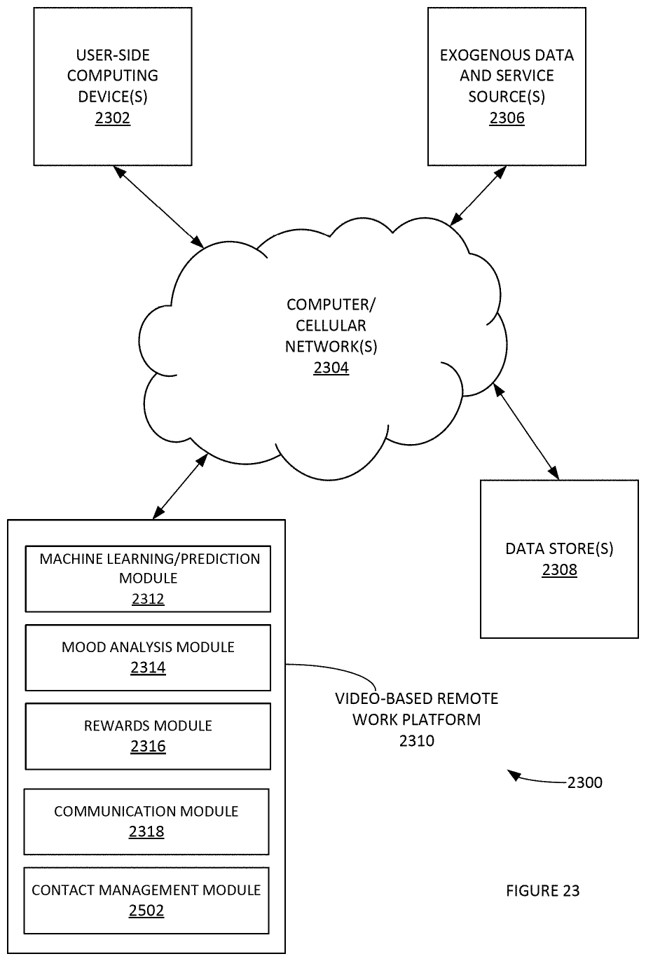

FIG. 23 illustrates an example system 2300 for implementing a video-based remote work platform 2310, according to some embodiments. Employees, management, and administrators can access video-based remote work platform 2310 via user-side computing device(s) 2302. Video-based remote work platform 2310 can obtain various data and services (e.g. coupons for employees, motivation images, etc.) from exogenous data source(s) 2306.

Video-based remote work platform 2310 can implement the processes, applications and methods of FIGS. 1-22 discusses supra. Video-based remote work platform 2310 can interact with the other elements of system 100 via computer network(s) 2304. Computer network(s) 2304 can include, inter alia: the Internet, cellular data networks, private enterprise networks, etc.

Video-based remote work platform 2310 can include machine learning/prediction module 2312. Machine learning/prediction module 2312 can perform the machine-learning functions of process 700 discussed infra. Machine learning/prediction module 2312 can obtain data from training data set(s) such as those stored in predictive inventory purchasing database 112. Machine learning/prediction module 2312 can create a predictive inventory purchasing model from training data from predictive inventory purchasing database 112. Machine learning/prediction module 2312 can obtain data from the other modules of system 100. Machine learning/prediction module 2312 can implement machine learning algorithms on the data and obtain patterns and inference from said data. Machine learning/prediction module 2312 can enable the various modules of Video-based remote work platform 2310 to perform specific tasks without using explicit instructions. Machine learning/prediction module 2312 can make predictions regarding future employee sentiment and performance. These predictions can be used to implement actions and suggestions to improve employee sentiment and performance (e.g. such as those discussed supra).

Machine learning/prediction module 2312 can utilize machine learning algorithms to recommend and/or optimize various automated inventory services.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alio: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

Video-based remote work platform 2310 can leverage exogenous data sources to obtain training data that may not be available internally. This can be used in addition to internally available training data (e.g. historical employee performance data, transcribed employee video reports, peer review data, supervisor review data, etc.). Data can be stored in data store(s) 2308.

Machine learning/prediction module 2312 can be used to generate models to automate and/or provide recommendations for the other functionalities of Video-based remote work platform 2310. Machine learning/prediction module 2312 can be use to optimize various functionalities as well. For example, machine learning/prediction module 2312 can be used to optimize gifts and motivational images sent to employees that optimize their emotional state, performance, and well-being.

Mood analysis module 2314 can be used to analyze an employee's emotional state and how it is related to performance. Mood analysis module 2314 can use employee video data, self reporting data, performance data, etc. Mood analysis module 2314 can various models generated by machine learning/prediction module 2312.

Rewards modules 2314 can enable management to provide each employee's rewards and bonus services. Rewards modules 2314 can utilize machine learning/prediction module 2312 to optimize rewards. In this way, each employee can receive rewards and other motivational content that is personalized to their specified preferences.

Communication module 2318 can manage the various inter-employee electronic communications. For example, communication module 2318 can manage business communication platforms. Communication module 2318 can provide and manage IRC-style features, including persistent chat rooms (channels) organized by topic, private groups, and direct messaging. Communication module 2318 can mange videotelephony services as well.

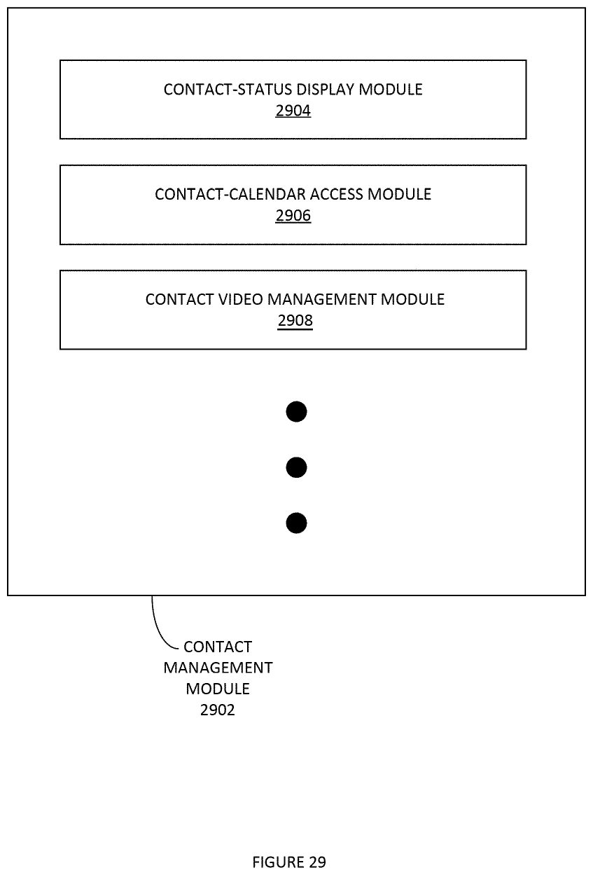

Video-based remote work platform 2310 can include contact management module 2902 discussed infra in FIG. 29. Contact management module 2902 can manage the information and interactions for screen shots 2500-2800. Contact management module 2902 can integrate with the desktop application of video-based remote work platform 2310. The desk top application can display n-number of user contacts (e.g. ten close user contacts, etc.). User contacts can be included in the display based on various criteria. For example, displayed contacts can be, inter alia: selected by the user, selected by the user's supervisor, ranked based on user interactions with other enterprise employees, based on user's team memberships, based on user's department, based on current user assignments/tasks, etc. The contact display population can be optimized and dynamic. The above criteria (and/or other criteria) can be used by a contact-display selection AI functionality to update and keep the n-number of displayed contacts as relevant as possible to the user's current status/duties within the enterprise.

As shown in the example of screen shots 2500-2800, ten people/contacts are at top of screen with roll-over capabilities. As shown, for each of the ten (10) contacts, the display shows that status update of each person. Contacts can be other employees the user works with closely. The contact icons/avatars can link to various services, such as inter alia; links to schedule a meeting, links send the contact a video message, links to view contact status details, links to view contact's calendar and/or interact with contact's calendar, links to the contact's daily schedule, links to the contact's plans for day, links to the contact's status can show what person is doing and what plan on doing later can search for other profiles via departments, teams, etc. Contact icons/avatars can tell others when will the contact be available without sending out messages, so each team member saves time. As noted, chat bot and AI assistant systems can be provided to offload and handle some of the interactions between contacts based on a contact's status.

Contacts can use photographs of themselves and/or avatars. In some examples, users can select various display options (e.g. color, font, image, content, etc.).

It is noted that in some examples, a contact can be an AI functionality capable of performing automated tasks within the enterprise. For example, the AI functionality contact can be an artificial intelligence program that creates images from textual descriptions (e.g. DALL⋅E), an AI program that performs human resources functions, chatbots, etc. In this way, AI entities within the enterprise can interface with human users in a meaningful way (e.g. send human users video messages, not contact human user when human user is busy, etc.).

Video-based remote work platform 2310 can include other systems such as, inter alia: voice-to-text systems, database managers, text messaging systems, web servers, email servers, digital image editors, videotelephony systems, online meeting servers, geolocation systems, etc.

Additional Systems

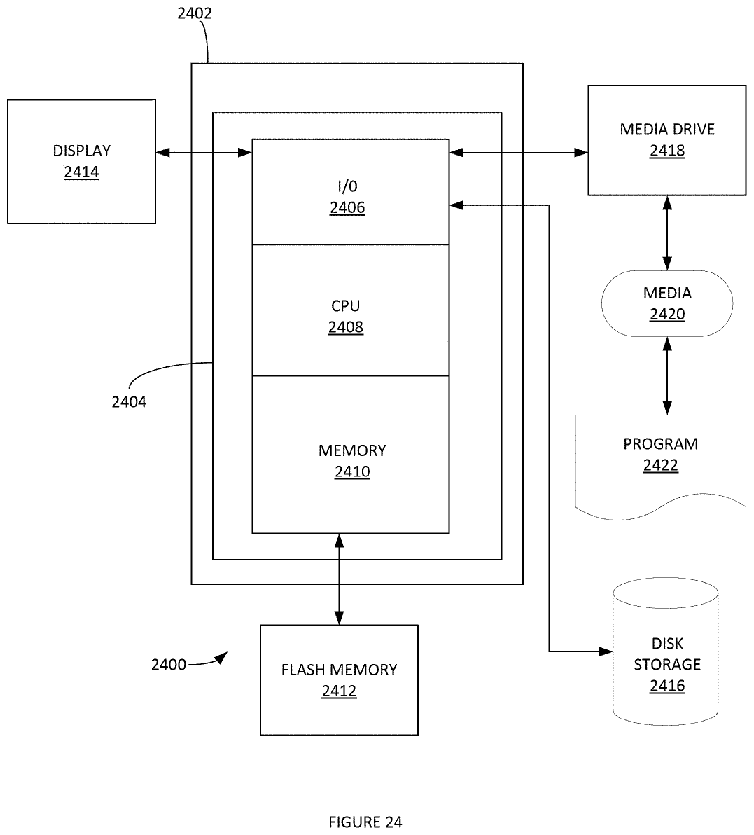

FIG. 24 depicts an exemplary computing system 2400 that can be configured to perform any one of the processes provided herein. In this context, computing system 1700 may include, for example, a processor, memory, storage, and I/O devices (e.g., monitor, keyboard, disk drive, Internet connection, etc.). However, computing system 2400 may include circuitry or other specialized hardware for carrying out some or all aspects of the processes. In some operational settings, computing system 2400 may be configured as a system that includes one or more units, each of which is configured to carry out some aspects of the processes either in software, hardware, or some combination thereof.

FIG. 24 depicts computing system 2400 with a number of components that may be used to perform any of the processes described herein. The main system 2402 includes a motherboard 2404 having an I/O section 2406, one or more central processing units (CPU) 2408, and a memory section 2410, which may have a flash memory card 2412 related to it. The I/O section 2406 can be connected to a display 2414, a keyboard and/or other user input (not shown), a disk storage unit 2416, and a media drive unit 2418. The media drive unit 2418 can read/write a computer-readable medium 2420, which can contain programs 2422 and/or data. Computing system 2400 can include a web browser. Moreover, it is noted that computing system 2400 can be configured to include additional systems in order to fulfill various functionalities. Computing system 2400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Contact Management System

As noted supra, video-based remote work platform 2310 can include contact management system 2902.

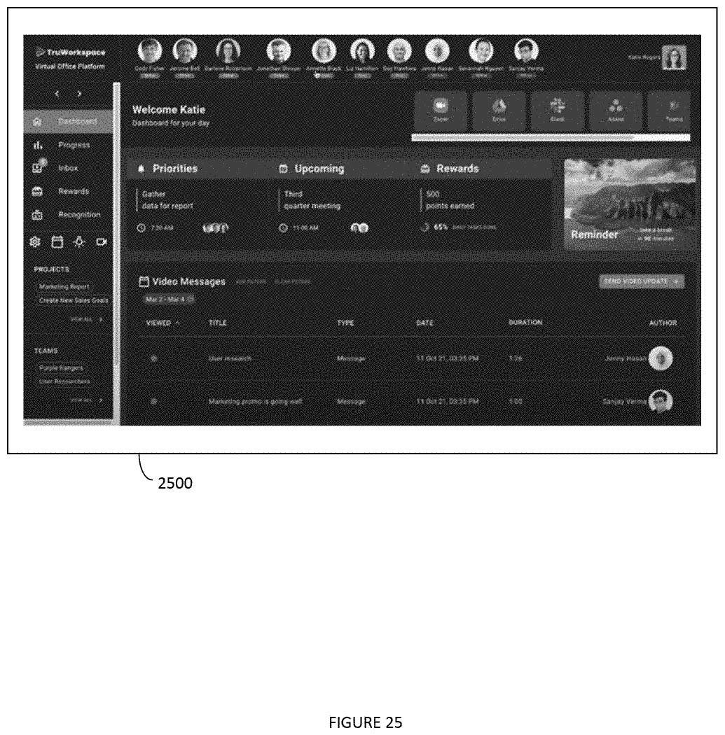

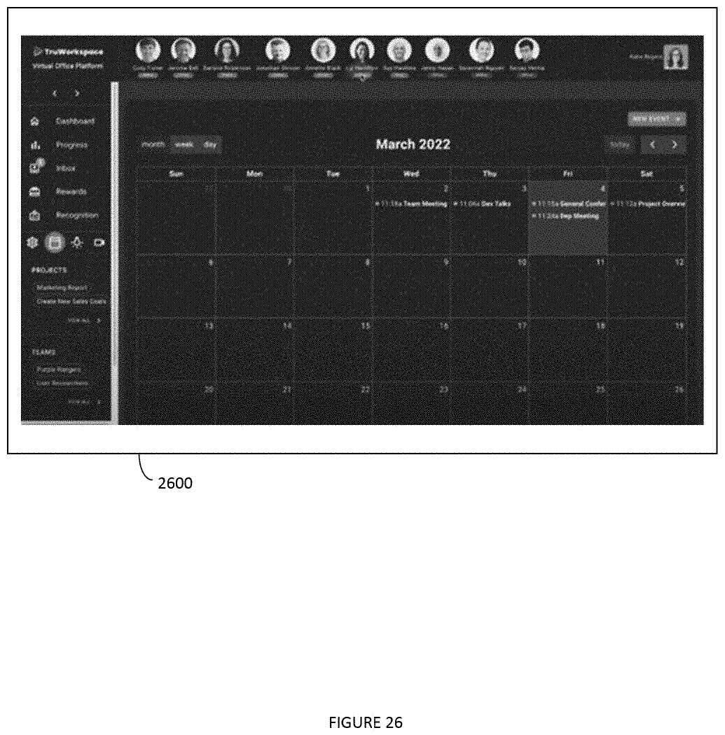

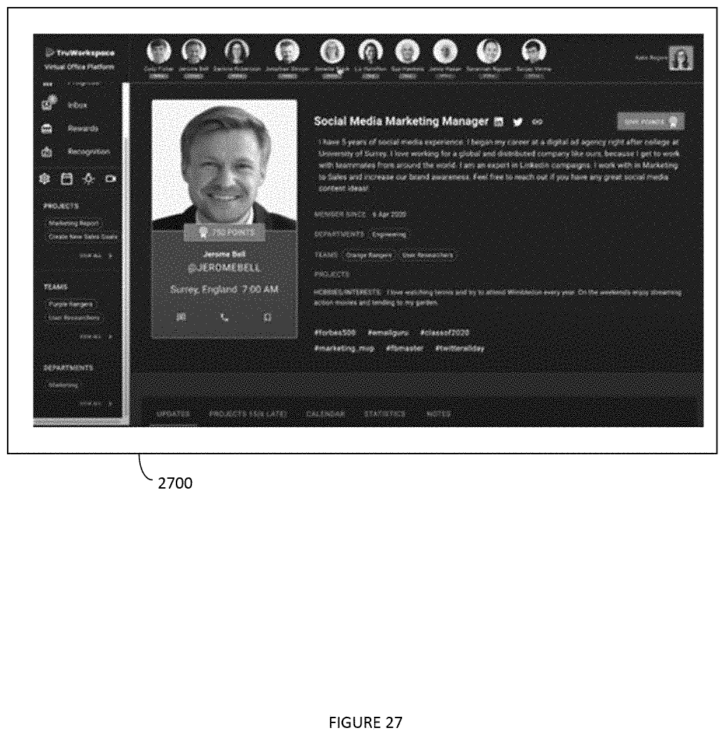

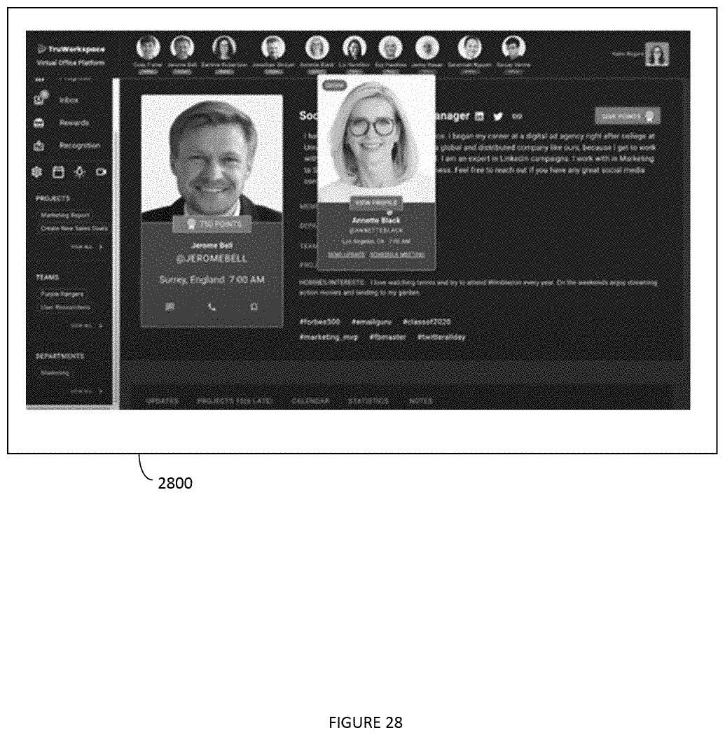

FIGS. 25-28 illustrate example screen shots 2500-2800 of dashboard view of a contact management system 2902, according to some embodiments.

FIG. 29 illustrates an example contact management system 2902, according to some embodiments. Contact management system 2902 can include, inter alia: contact-status display module 2904, contact-calendar access module 2906, contact video management module 2908, etc. Contact management system 2902 can manage the functionalities, content, delivery, display, etc. of the screen shots 2500-2800. Contact management system 2902 can interface with the other relevant system of FIG. 23.

Users can use contact-status display module 2904 to manage the content of the own contact avatars. Users can use contact-status display module 2904 to manage the display of other user avatars in their own desktop application. Contact-status display module 2904 can be used to update a user's current status, future status, hyperlinks to current projects, etc. Contact-status display module 2904 can include a chat bot assistant that can interact with other users on behalf of the user. In this way, the user can be reached when busy if other priority projects or needs are to be taken care of. The chat bot assistant can answer basic questions on behalf of the user when the user is in a busy state. The chat bot assistant can inform the user of incoming messages, tasks, etc. that may have come in while the user was in a busy state. Users can update the number of contacts that are visible in the dashboard application.

Contact-calendar access module 2906 can enable other users (and/or AI functionalities acting on behalf of user) to access the user's calendar system. Users can use contact-calendar access module 2906 to set various privacy settings on their calendar system. For example, based on the other user's status/position, the other user may only be able to see relevant portions of the user's calendar and/or access various calendar operations (e.g. schedule a meeting, cancel a meeting, invite other team members to a meeting etc.).

Contact video management module 2908 can enable users to create and send video messages to other contacts. Users can generate template contact messages. Users can generate and send pre-generated video messages. For example, when a user has a repetitive explanation, the user can generate a video message, and have it set as an automatic reply when a relevant incoming query is received. For example, an IT employee can perform the same explanation several times a week. The IT employee can create a video message that addresses the query and have it sent when the contact video management module 2908 detects that query. Contact video management module 2908 can concatenate a plurality of video messages into a single message and send it to a user. For example, five members of a team can each generate one or more messages about a project and send it to a project manager. Contact video management module 2908 can detect that these messages are about the same project and addressed to the same project manager. Accordingly, contact video management module 2906 can concatenate these into a single message and then send it to the project managers in box.

Contact management system 2902 can utilize the ML functionalities of system 2300 to automate and/or optimize any content or tasks it performs. Contact management system 2902 can also leverage third-party systems to improve content. For example, a third-party animated video generation service can be accessed to generate animations that can be included in video messages. A third-party mapping service can be used to generate driving instructions that can be included in a video message. A third-party educational service can be used to generate specific technical instructions in a video message. These are provided by way of example and not of limitation.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by this United States patent:

1. A computerized system comprising:
a video-based remote work platform of an enterprise, wherein the video-based remote work platform manages and provides a remote work dashboard, the video-based remote work platform comprising:
a contact management system that manages a set of employee information and a set of employee interactions, wherein the contact management system is integrated with the desktop application of the video-based remote work platform, and wherein the contact management system manages a display of a set of contacts of an employee, and wherein the contact management system comprises:
contact-status display module that manages a content of the employee's contact avatars in the remote work dashboard, is used to update a employees's current status in the remote work dashboard, a future status of the employee in the remote work dashboard, a current project of employee in the remote work dashboard;
contact-calendar access module that manages a calendaring system of the employee, enables other contact to access the user's calendar system; and
contact video management module that enables the employee to create and send a video message to set of contacts, enables the employee to generate a template contact message and enables the employee to generate and send a pre-generated video message.

2. The computerized system of claim 1, wherein the set of contacts of the employee comprises ten (10) employees of the enterprise.

3. The computerized system of claim 2, wherein the set of contacts of the employee are on a same team of the enterprise.

4. The computerized system of claim 3, wherein the set of contacts are included in the display based on a set of specified criteria.

5. The computerized system of claim 4, wherein the set of specified criteria comprises a set of other employees selected by the employee.

6. The computerized system of claim 5, wherein the set of specified criteria comprises a supervisor of the employee.

7. The computerized system of claim 6, wherein the set of specified criteria comprises a set of ranked employees, wherein the ranked employees are sorted and ranked based on a set of past interactions with other enterprise employees with the employee.

8. The computerized system of claim 7, wherein the ranked employees are sorted and ranked based on an employee's team memberships.

9. The computerized system of claim 8, wherein the ranked employees are sorted and ranked based on a current employee tasks.

10. The computerized system of claim 9, wherein the contact display population is optimized by one or more machine learning algorithms and are dynamically updated as the employee changes the current employee task.

11. The computerized system of claim 10, wherein the contact-status display module comprises a chat bot assistant that interact with other contacts on behalf of the employee when the employee is in an unavailable state.

12. The computerized system of claim 11, wherein the employee uses contact-calendar access module to modify a privacy settings on the calendaring system.

13. The computerized system of claim 12, wherein a displayed contact avatars comprises a hyper to a specified service.

14. The computerized system of claim 13, wherein the specified service comprises: a hyperlink to schedule a meeting with the calendaring system of the employee, a hyperlinks send a contact a video message, a hyperlink to view a contact's status details, and a hyperlink to view the contact's daily schedule.

15. The computerized system of claim 14, wherein the contact management system comprises a contact-display selection AI functionality that updates and maintains the displayed contacts in a relevant state to employee's current duties within the enterprise.
